(19) United States
(12) Patent Application Publication
(10) Pub. No.: US 2009/0166170 A1
(43) Pub. Date: Jul. 2, 2009

(54) Porous honeycomb water treatment device

(76) Inventor: Gary Sun, Taipei (TW)

Correspondence Address: Gary Sun, P.O.Box 166-13, Taipei, 115, TW

(21) Appl. No.: 12/003,402

(22) Filed: Dec. 26, 2007

(51) Int. Cl. B01D 3/14

(52) U.S. Cl. 202/161

(57) ABSTRACT

A porous honeycomb water treatment device washes out deposited salt automatically with high heat exchange rate to produce sufficient fresh water, a hollow, vacuum, and high pressure distillation column, where salt water alternatively heated up to 100° C. or cooled down to 0˜18° C.; a bottom product exit (13) formed at a bottom of the fractionator (1); an inlet pipe (11) disposed above the fractionator (1) injects salt water in the fractionator (1); a top product outlet pipe (12) disposed above the fractionator (1) discharges water vapor out of the fractionator (1); and at least, one tray (4) disposed inside the fractionator (1) equidistantly arranged in neat stack; the tray (4) is composed of a plurality of heat pipe (40) filled with working fluid mixed with nano-scale metallic particulates; the heat pipes (40) are arrayed in parallel and equidistantly supported on a hollowed-out frame (41) at an inclined angle (θ).

### FIELD OF THE INVENTION

The present invention is related to a porous honeycomb water treatment device.

### DESCRIPTION OF PRIOR ARTS

Although 70% of the mother earth surface is filled with water, but not all freshwater. Though water resource developing plan are never stop running, efforts to furnish fresh water suitable for human consumption and irrigation made renowned great rivers around the world are replete with water power and dam construction, but gradual resource shortage problem still is floated to the top of water for decades. Fresh water obtained through several kinds of water desalination treatments such as distillation, Aero-Evapo-condensation-Process (AECP), reverse osmosis, electrolysis, and ion exchange.

Distillation and reverse osmosis are recognized as two of good ways to provide better fresh water. Though distillation may produce large amount of fresh water with inexpensive, durable boilers, but energy consumption and environmental impact are more serious than others. Person skilled in the art have provided TW580109 entitled “Water distillation without heat contamination” to King-Fa Wu on Mar. 11, 2004. it disclosed that a water desalination device incorporated to a trash incinerator comprising a first flue, and a desalination element; while the incinerator includes a combustion chamber, a gate, a burner, a fresh water reservoir on top of the incinerator fed fresh water by an inlet pipe, but the fresh water vapor expelled out via an outlet pipe; in addition, an exhaust pipe for fume extraction connected between the combustion chamber and the first flue. Both water vapor and fume dissipate thermal energy along the pipes (i.e. outlet pipe and exhaust pipe respectively) through the desalination element. A sprinkler sprays salt water through a spiral net mounted inside the first flue increases heat exchange rate; the desalination element includes a salt water reservoir or boiler filled with salt water boiled by increase of heat dissipated along the outlet pipe, and the exhaust pipe passed therethrough to distill salt water, and a steam condensing apparatus on top of the salt water reservoir or boiler for vapor of salt water condensed into fresh water. The steam condensing apparatus clad with cooling pipes for circulating water as coolant to convert vapor into fresh water; and, at least, one layer of tray in the steam condensing apparatus collects and drains off fresh water.

In TW 580109, crude oil fed into the incinerator and burned as fuel, whose fume contains harmful dioxin, carbon dioxide emission; by which dust collector or fume filter is required to abide by environment protection regulation to make a bid to reduce environmental impact of permeation by wind etc. Salt water boiled indirectly by increase of heat dissipated by the pipes. Not only a large amount of wasted heat (high enough than the desalination required) and fume is produced, but also salt deposited in the pipes infiltrates and retards the desalination device. Users have to clean up the pipes etc. How to improve heat exchange rate to salt water converted into fresh water, further avoid salt deposited on the pipes are concerned by the invention.

### SUMMARY OF THE INVENTION

A porous honeycomb water treatment device can be realized by two embodiments. A first embodiment of the porous honeycomb water treatment device comprising a fractionator (1) is a hollow, vacuum, and high pressure distillation column, where salt water alternatively heated up to 100° C. or cooled down to 0˜18° C.; a bottom product exit (13) formed at a bottom of the fractionator (1); an inlet pipe (11) disposed above the fractionator (1) injects salt water in the fractionator (1); a top product outlet pipe (12) disposed above the fractionator (1) discharges water vapor out of the fractionator (1); and, at least, one tray (4) disposed inside the fractionator (1) equidistantly arranged in neat stack; the tray (4) is composed of a plurality of heat pipe (40) filled with working fluid mixed with nano-scale metallic particulates; the heat pipes (40) are arrayed in parallel to one another and equidistantly supported on a hollowed-out frame (41) at an inclined angle (θ).

The second embodiment of a porous honeycomb water treatment device comprising a hollow, vacuum, and high pressure vapor fractionator (1), a bottom product exit (13) formed at a bottom of the fractionator (1), at least, one inlet pipe (11) disposed above the fractionator (1) injects salt water in the fractionator (1), a top product outlet pipe (12) disposed above the fractionator (1) discharges water vapor out of the fractionator (1), at least, one set of trays (4) fit through the fractionator (1) are equidistantly arranged, each of the trays (4) is composed of a plurality of heat pipes (40) arrayed in parallel to one another and equidistantly supported on a hollowed-out frame (41) at an inclined angle (θ), at least, a tray (4) clad with a condenser (43) at a higher end to wrap up around higher ends of the heat pipes (40), and the tray (4) clad with a heating device (42) at a lower end to wrap up around lower ends of the heat pipes (40).

### BRIEF DESCRIPTION OF THE DRAWINGS

FIG. 1: shows a perspective view of the porous honeycomb water treatment device of the present invention;

FIG. 2: shows a partial sectional view of FIG. 1;

FIG. 3A: shows a top view of the tray of the invention;

FIG. 3B: shows a top view of heat pipes oriented transversally to the same of FIG. 3A of a neighbored vertical aligned tray;

FIG. 3C: shows a top view of the trays of FIGS. 3A and 3B, where layers of heat pipes are interleaved in an up and down relationship, but not superposed or intersected;

FIG. 4: shows a diagrammatic view of desalination process of salt water converted into top product fresh water and bottom product brine in the fractionator;

FIG. 5: a schematic view of the porous honeycomb water treatment device in practice;

FIG. 6: shows a perspective view of an alter embodiment of the porous honeycomb water treatment device;

FIG. 7: shows a sectional view of FIG. 6; and

FIG. 8: shows a schematic view of the alter embodiment of the porous honeycomb water treatment device in practice.

### DETAILED DESCRIPTION OF PREFERRED EMBODIMENTS OF THE PRESENT INVENTION

The present invention is described in detail according to the appended drawings hereinafter.

### First Embodiment

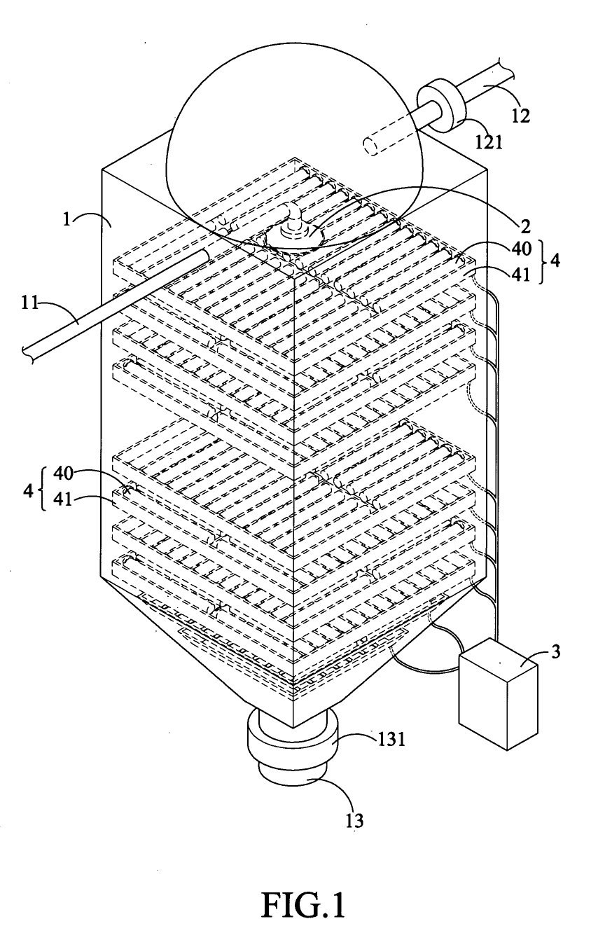

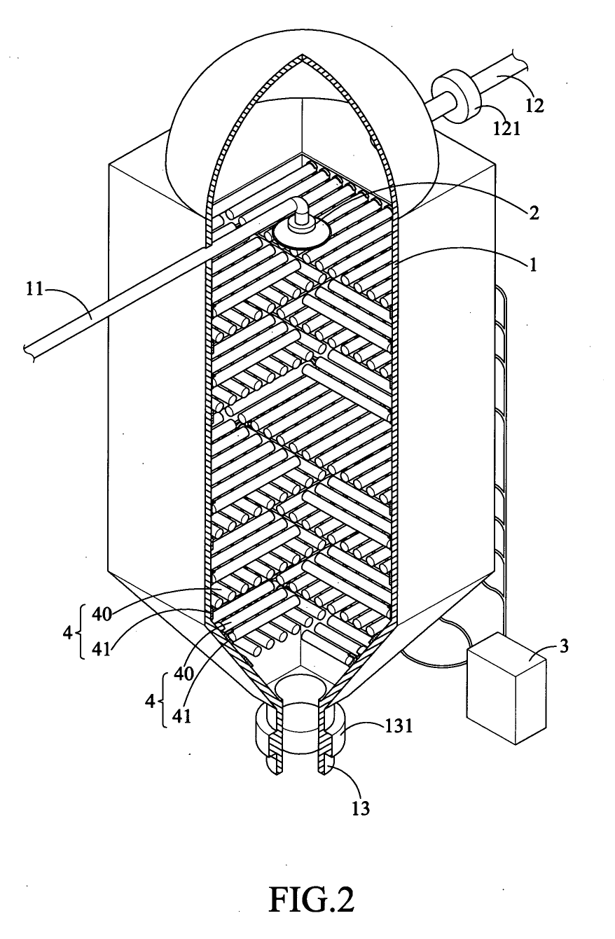

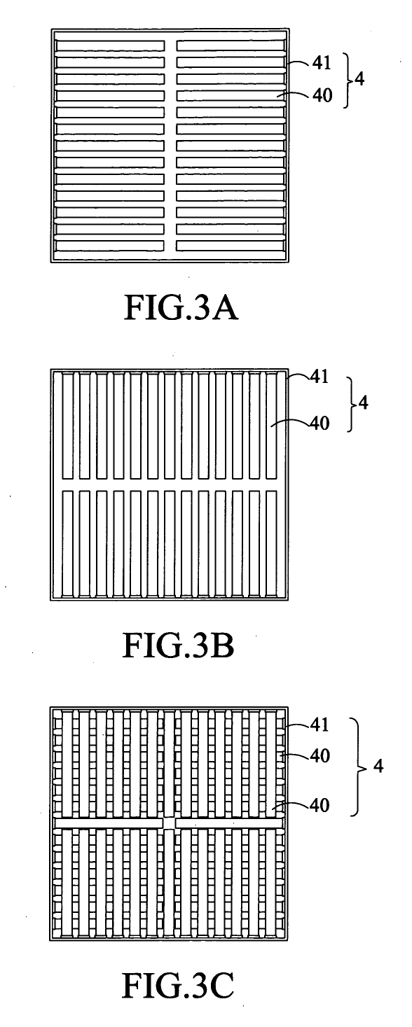

As shown in FIGS. 1˜3C, a porous honeycomb water treatment device includes a fractionator (1) allows salt water exposed to high pressure and vacuum condition; a bottom product exit (13) formed at a bottom of the fractionator (1); an inlet pipe (11) disposed above the frationator (1) injects salt water into the fractionator (1); a top product outlet pipe (12) disposed above the fractionator (1) discharges water vapor out thereof; at least, one tray (4) disposed inside the fractionator (1), when more than two trays (4) vertical aligned in a neat stack with equidistant gap kept between each two neighbored trays; each of which having a plurality of heat pipes (40) arrayed in parallel to one another and equidistantly supported on a hollowed-out frame (41).

Take advantage of heat pipes (40) can be heated instantly inside the fractionator (1); which is operated under high pressure gets, at least, a low to medium vacuum. Therefore, a boiling point of salt water can be lowered. In addition, the sprinkler (2) connected to the inlet pipe (11) sprays rain drop like salt water (5) reduced to small sizes fully into the fractionator further drips down to the heat pipes (40) to be evaporated soon.

Layers of the trays (4) are vertical aligned in a neat stack with an equidistant gap retained between each two neighbored trays. The trays (4) may be classified into different sections, each of which is characteristic of a decrement working temperature and delayed working time in order to condense salt water more efficiently. For example, layers of trays (4) can be divided into four sections. Heat pipes (40) of a first section are activated under temperature in the range of 80° C.˜100° C.; heat pipes (40) of a second section are activated under temperature of 80° C. but five minutes later than the first section; heat pipes (40) of a third section are activated under temperature of 60° C. further delayed three to five minutes than the second section; heat pipes (40) of a fourth section are further activated under temperature of 60° C. delayed three to five minutes than the third section. According to configuration as mentioned above, spread out rain drop like salt water (5) is evaporated through those sections.

Heat pipes (40) are equidistantly arrayed in parallel to one another. The inlet pipe (11) spreads out salt water fallen to layers of heat pipes (40) on the trays (4). Though the trays are vertical aligned, but pipes (40) on the neighbored trays are interleaved with each other in an up and down relationship, but not superposed or intersected, to form a porous honeycomb like heat pipes matrix. Atomization of the rain drop like salt water (5) is available for passing through layers of trays (4) due to interstices of heat pipes (40) matrix are retained with roomy space in between. Each layer of trays (4) is fully in contact with salt water without consuming too much power for evaporation.

The tray (4) is electrically connected to a thermostat (3), by which an anode, and a cathode on both ends of the heat pipe (40) connected to the power source can be altered. Thereby, the heat pipe (40) is alternately operated under a heated-up process for evaporation of salt water, or a cooled-down process for dispersion of salt water washing out deposited salt. Since each of the heat pipes (40) on the tray (4) is stably supported on the hollowed-out frame (41), both ends of the heat pipe (40) is connected to the frame (41) with both anode and cathode, polarity alteration happened to both ends of the heat pipes is automatically controlled by the thermostat (3). The heat pipe (40) filled with working fluid with nano scale metallic particulates contained in the working fluid; both present different phase transitions through gasified, liquefied, and solid phases to absorb or releases heat enormously. That is determined by the polarity alteration to the ends of the heat pipe (40) under control of the thermostat (3). Phase transitions inside the heat pipes (40) can be defined through high temperature, moderate temperature, and low temperature. For example, as disclosed in TW M293423 entitled “heat pipe” to Tsai, Ming Kun on Jul. 1, 2006, it defined the heat pipe filled with deoxygenated media mixed with nano scale metallic particulates; both of them can be gasified at high temperature in the range of 250˜450° C. However, under low working temperature below 0° C., deoxygenated media are liquefied, but timely gasified to increase heating up the low temperature environment. Under moderate working temperature in the range of 0˜250° C., liquefied deoxygenated media and solid nano scale metallic particulates absorbed heat undergo a phase shift. Nano scale metallic particulates selected from aluminum, iron etc. In U.S. Pat. No. 7,168,480 entitled “Off-axis cooling of rotating devices using a crank-shaped heat pipe” assigned to Jankowski et al. on Jan. 30, 2007, working fluid selected from helium, hydrogen, pentane, and potassium.

Or as CN 1470592 published on Jan. 28, 2004 entitled “working fluid of heat pipe” to Yuan et al. it disclosed that working fluid is composed of hydrogen peroxide 65˜71%, potassium hydroxide 3˜6%, Magnesium peroxide 0.3˜0.6%, potassium sulfate 0.3˜0.6%, and the rest are distilled water. The working fluid applied to patented CN 2765127 entitled “heat pipe” to Yuan et al. on Mar. 15, 2006.

Accordingly, the heat pipes (40) heats up salt water for evaporation, or cools down salt water to wash out the deposited salt. The heat pipes (40) of the invention are oriented transversally to the same on the neighbored vertical aligned trays (4) inside the fractionator (1) likely a porous honeycomb configuration, where surfaces of all the heat pipes are thoroughly exposed to rain drop like salt water (5). Salt deposited on all the heat pipes is washed out.

The heat pipes (40) on one tray are preferably oriented transversally to the same on the neighbored trays at a right angle (90°); each of heat pipes (40) may be fully in contact with salt water spread up in thin umbrella shape further dripped down through roomy interstices between the interleaved layers of pipes like showers. Either evaporation or condensation performance can be realized by the pipes fully in contact with the salt water.

As above, at least, one sprinkler (2) connected from a proximal end of the inlet pipe (11) to an inner side of the hollow, vacuum, and high pressure fractionator (1), where the sprinkler (2) is hung from a top of the fractionator (1) opposite to an uppermost layer of tray (4) at a distance. Salt water is fully spread out into droplets in a thin umbrella shape to the trays (4). Droplets reduced to small sizes are easy to be atomized and evaporated, when fallen to the heated pipes (40). Furthermore, the sprinkler (2) hung over the uppermost tray (4) can expand available area to accommodate salt water fully in contact with the trays (4). Power dissipated to the trays converted to heat for evaporation of salt water is consumed intermittently, and used timely without wasting too much power electricity. Droplets dripped down to the pipes (40) first absorb radiation heat therefrom; also radiation heat remained in water vapor around the pipes (40) is absorbed by the droplets. Therefore, the salt water can be evaporated promptly. Easy evaporation is helpful for less power consumption during heat up process.

The top product outlet pipe (12) is equipped with a relief valve (121), when excess water vapor inside the fractionator (1) is increased to a predetermined vapor pressure value; the relief valve (121) is open to discharge the excess water vapor. Therefore, the top product outlet pipe (12) can be filled with water vapor again, further can prevent discharged vapor from flowing back to cause physical damage to the fractionator (1).

A weight valve (131) is disposed to the bottom product exit (13) for draining out brine. In other words, deposited salt, concentrated salt water, and salt water are combined together to form a brine, which is temporarily accumulated to the exit (13) till a predetermined weight value of the brine, such as five or ten kilogram, is achieved; where the weight valve (131) is open to dump brine automatically. The fractionator (1) is operated more efficiently with less heat loss.

Since a top end of the vacuum high pressure fractionator (1) is cambered in shape, or shaped as a four facet pyramid, thus the top product water vapor can be drawn from the top end to the top product outlet pipe upward aggregately to facilitate water vapor condensed to form droplets and dripped down into the outlet pipe by an accumulated weight.

### Second Embodiment

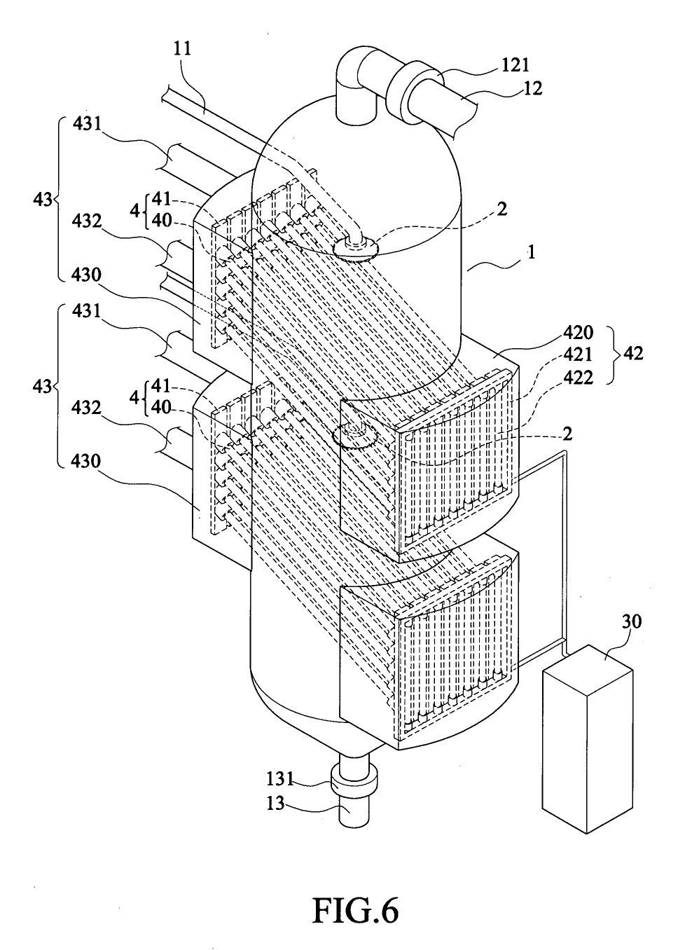

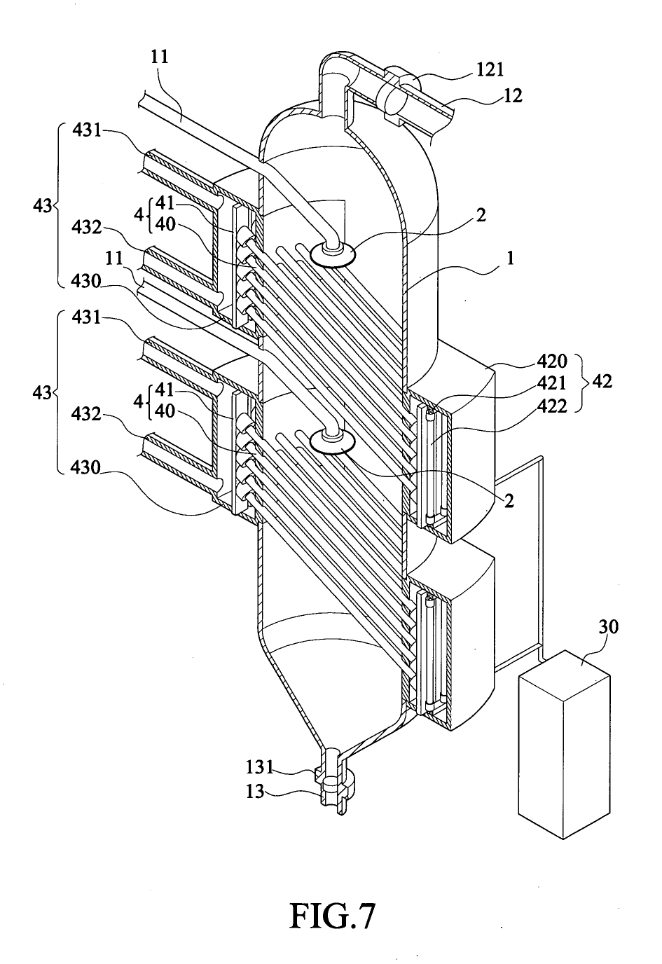

As shown in FIGS. 6 and 7, a porous honeycomb water treatment device comprising a hollow, vacuum, and high pressure fractionator (1), a bottom product exit (13) formed at a bottom of the fractionator (1), at least, one inlet pipe (11) centrally disposed above the fractionator (1) injects salt water in the fractionator (1), a top product outlet pipe (12) disposed above the fractionator (1) discharges water vapor out of the fractionator (1), at least, one set of trays (4) fit through the fractionator (1) are equidistantly vertical aligned in a neat stack inside the fractionator (1), each of the trays (4) is composed of a plurality of heat pipes (40) arrayed in parallel to one another and equidistantly supported on a hollowed-out frame (41) at an inclined angle (θ); at least, each of the tray (4) is clad with a condenser (43) at a higher end to wrap up higher ends of the heat pipes (40); at least, each of the tray (4) clad with a heating device (42) at a lower end to wrap up lower ends of the heat pipes (40).

Each of the trays (4) includes a plurality of heat pipes (40) distributed in parallel with an equidistant gap kept between two adjacent pipes (40) supported on a hollowed-out frame (41). Salt water fed by the inlet pipe (11) sprays into interstices between interleaved heat pipes (40) on neighbored trays (4) vertical aligned in a neat stack fully in contact with atomized salt water. Trays (4) disposed in the fractionator (1) at an inclined angle (θ) for washed out deposited salt and droplets drip down rapidly by gravitational attraction.

Condenser (43) and heating device (42) are applied to heat up or cool down the heat pipes (40) of the trays (4) indirectly. Not only no contamination, but also no electric leakage may be caused by such indirect heating up or cooling down process.

Said heating device (42) can be electrically connected to a programmable logic controller (PLC) (30), while said condenser (43) can also be electrically connected to the PLC (30). (not shown) Operations of the heating device (42) and the condenser (43) are controlled by the PLC (30) as a real time system since output results must be produced in response to input conditions within a bounded time (for example, 5˜10 seconds). Operations of the heating device (42) and the condenser (43) are precision controlled to convert the heat pipes (40) to heating up process or cooling down process. The trays (4) can be used to evaporate salt water during heat up process, or salt deposited on the heat pipes (40) can be washed out during cool down process.

Said heating device (42) includes housings (420) wrap up around lower ends of said heat pipes (40); each of evaporators (422) adapted to a lower end of each the trays (4) respectively; the evaporators (422) are fixed on a hollowed out frame (421). Under such circumstance, the heating device (42) heats up the heat pipes (40) efficiently, and power dissipation through the heating device (42) converts into heat efficiently.

Said evaporator (422) is a heat pipe made of heat-resistant quartz, when heated, even power is off, the evaporator (422) still can be kept heated for a longer while without heat contamination or heat loss.

Said condenser (43) includes housings (430) wrap up around higher ends of said heat pipes (40), said housings (430) are in connection with cooling pipes (431) for drawing water as coolant in the housings (430), and an exhaust pipe (432) for expelling out said water from the housing (430). Cooling pipes (431) and exhaust pipes (432) are arranged for easily lowering temperature of the pipes (40) under control.

Inclined angles of the set of trays (4) are limited in the range of 5°˜45°, by which the trays (4) can be operated efficiently to wash out deposited salt on the heat pipes (40).

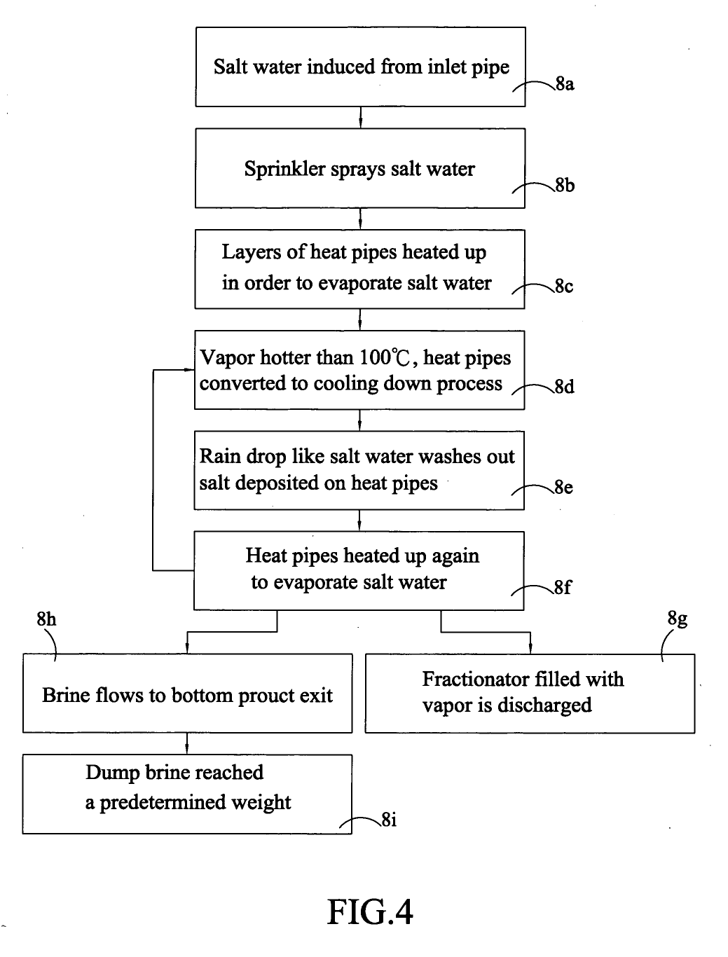

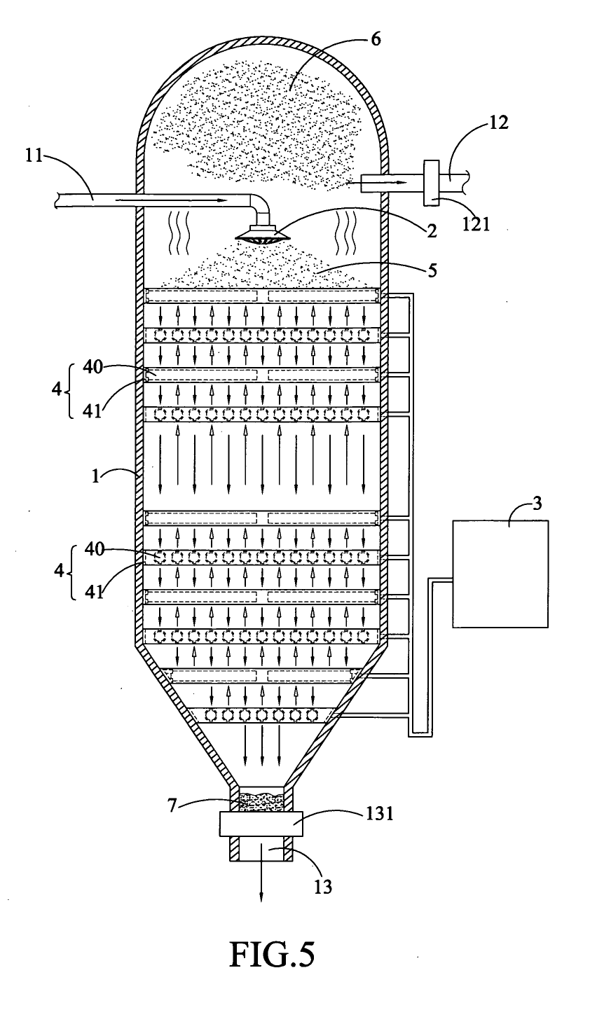

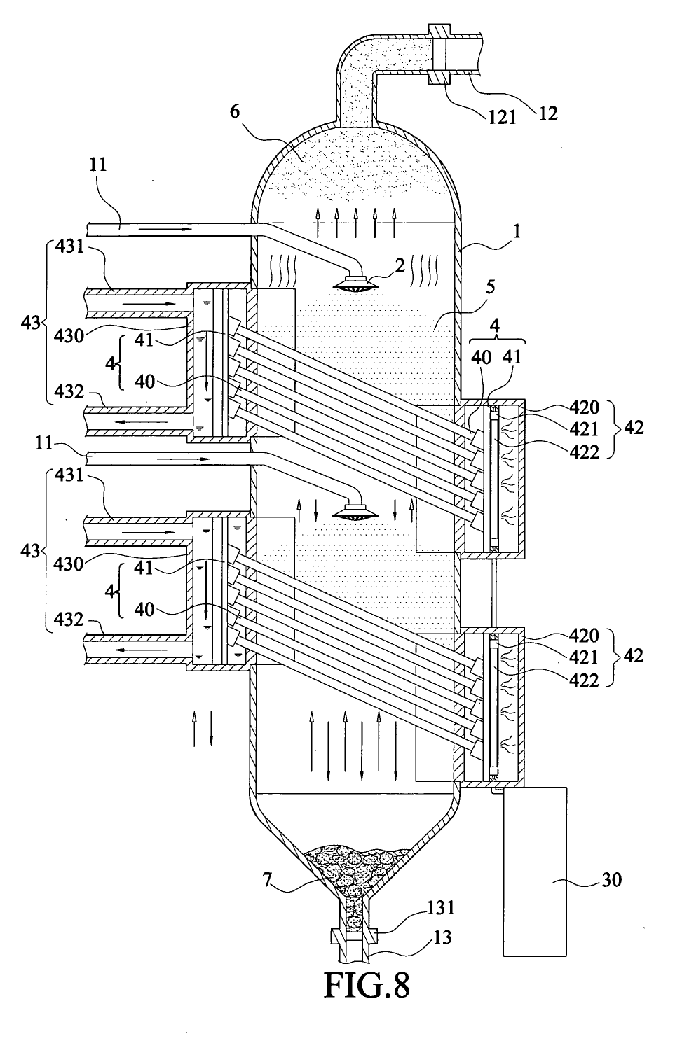

As shown in FIGS. 4 and 5, a diagrammatic view of desalination process of salt water converted into fresh water, and a schematic view of the porous honeycomb water treatment device in practice are illustrated. As shown in FIG. 8, a schematic view of another embodiment of the porous honeycomb water treatment device in practice is illustrated.

Salt water (8a) induced through the inlet pipe (11), and the sprinkler (2) connected to a proximal end of the inlet pipe (11) sprays into the fractionator (1) likely rain drops in a thin umbrella shape, rain drops can be reduced to small sizes, which are evaporated promptly.

Rain drop like salt water (5) drips down to layers of heat pipes (40) converted into evaporated salt water (8c) under a high pressure but hollow, vacuum condition inside the fractionator (1). In addition, the sprinkler (2) connected to the inlet pipe (11) sprays rain drop like salt water (5) reduced to small sizes. Therefore, whenever the heat pipes (40) are heated to a high temperature, more vapor will be produced with less time it takes for evaporation. For example, when the heat pipes (40) are operated under temperature about 30° C., rain drop salt water sprays into droplets drip down to the heat pipes (40) may atomize and absorb radiation heat etc., to form water vapor, but when the heat pipes (40) are operated under temperature in the range of 40° C.˜50° C., rain drop salt water (5) drips down to the heat pipes (40) converts into vapor more easily than the same operated under temperature 30° C.

When water vapor inside the fractionator (1) is heated up to a temperature above 100° C., then the heat pipes (40) converted to cooling down process (8d) under control of the thermostat (3). The heat pipes (40) are altered from heating up process to cooling down process under temperature in the range of 18° C. to 0° C. Boiled and evaporated salt water produces salt (8e) deposited on the heat pipes (40) is further washed out by rain drop like salt water drips down to the heat pipes (40). Then the heat pipes (40) altered to heating up process again to evaporate salt water (8f). Since the deposited salt (8e) washed out from the heat pipes (40), vapor produced by the prior evaporation still leaves thermal radiation heat in the fractionator (1) around the pipes (40). While the heat pipes (40) converts to cooling down process about 5˜10 seconds mainly to wash out salt (8e) deposited on the heat pipes (40). When the heat pipes altered between cooling down and heating up process, heat loss is reduced to a minimum. Therefore, when the heat pipes (40) are heated up, the mechanism is to minimize power dissipated through the heating device converts into heat. When the heat pipes (40) are heated again for evaporation of rain drop like salt water, power consumption is limited to an extent that the dissipated power is required a minimum each time electricity power consumed only 5˜10 seconds for evaporation.

As above, the steps are processed through repeated times, the high pressure fractionator (1) is filled with water vapor (8g) released from the opened relief valve (121) to a reservoir, where the water vapor of salt water converted into fresh water. While the deposited salt mixed with the rain drop like salt water (5) and some concentrated salt water combined as a brine (7) drip down to a bottom of the fractionator (1) by gravitation attraction. The brine (7) further flows to the bottom product exit (8h), whenever a weight of the brine (7) is accumulated to a predetermined weight value, such as 5 kilogram or 10 kilogram, the brine (8i) is released from the bottom product exit (8h). The brine (7) applied as coolants of air conditioner, automobile's radiator, or dye brine used in dye industry, and high concentration of sodium in the brine solution reverses ion exchange process in semi-conductor plant.

As shown in FIG. 8, when water vapor in the fractionator (1) is hotter than 150° C., under control of PLC (30), let the condenser (43) cools down the heat pipes (40). Through heating up process, due to most salt water evaporated to water vapor, residues of salt water on the pipes (40) is dehydrated to salt and deposited on the pipes (40). Whereby, since the hollow pipes (40) converted to cooling down process, rain drop salt water drips down to the pipes (40) can wash out the deposited salt. Further the pipes (40) are inclined at an angle (θ), deposited salt and condensed salt water drops drip down at an acceleration caused by gravitation attraction. Then the heating device (43) is applied to heat up the pipes (40) again to evaporate salt water. Because heat exchange between heating up and cooling down process are precision operated bounded by a time limit. (for example, 5˜10 seconds for heating) Heat loss is reduced to a minimum. While when heated, the saved thermo heat or radiation heat is absorbed by the droplets dripped down to the pipes (40), thereby, salt water can be evaporated again easily.

### Advantages of Embodiments of the Invention

1. Take advantage of heat pipes (40) can be heated instantly inside the fractionator (1); which is operated under high pressure gets, at least, a low to medium vacuum. Therefore, a boiling point of salt water can be lowered and filled with vapor more and more. In addition, the sprinkler (2) connected to the inlet pipe (11) spreads out rain drop like salt water (5) reduced to small sizes fully in contact with the heat pipes (40) to be evaporated soon.

2. Under control of the thermostat (3), the heat pipes (40) can be altered from heating up process to cooling down process instantly, which makes salt deposited on the heat pipes as salt water is already evaporated. But, rain drop like salt water sprays onto the heat pipes (40) once again, salt deposited on the heat pipes (40) is washed out and dropped to lower layers of heat pipes (40) to be evaporated again. Desalination treatment can be cyclically operated without stop or break. Water vapor is drawn upward and collected from the top product outlet pipe (12) other than salt, brine, and salt water mixed to a bottom product exit (13) by gravitation attraction. When the weight valve (131) is actuated by brine etc., carry a weight amount to a predetermined weight value; the weight valve (131) is open to dump brine from the bottom product exit (13) as a by-product.

3. Sprinklers (2) connected to the inlet pipe (11) sprays rain drop like salt water (5) into the fractionator (1) in a thin umbrella shape, which enlarge available area, enforce small size drops drip to the trays (4). Salt water reduced to small sizes, not only the salt water can be evaporated soon, but also most salt water dispersion on the trays is in contact with the heat pipes.

4. Trays (4) disposed inside the fractionator (1) are substantially configured with a plurality of heat pipes (40) supported on the hollow out frame, pipes (40) are oriented transversally to the same oriented on the neighbored trays vertical aligned in neat stack. Salt water drips down through interleaved, but not superposed or intersected, layers of heat pipes (40). All the salt water can be evaporated, deposited salt can be cleaned up soon from the heat pipes (40), when cooled.

5. Heat pipes (40) of the trays (4) are powered by electricity instead of crude oil burner. No fume or smoke will be produced, and no dioxin, carbon dioxide, carbon monoxide, sulfuric oxide, etc., may contaminate the surrounding environment.

6. Condenser (43) and heating device (42) are applied to heat or cool the salt water indirectly. Not only no contamination, but also no electric leakage may be caused by such indirect heating up or cooling down process. Under control of thermostat, precision operations executed on some data stored and extracted from a programmable logic controller (PLC) (30) adapted for the fractionator (1) is aimed to lower power consumption.

What is claim claimed:

1. A porous honeycomb water treatment device comprising:
a fractionator (1) is a hollow, vacuum, and high pressure distillation column, where salt water alternatively heated up to 100° C. or cooled down to 0˜18° C.;
a bottom product exit (13) formed at a bottom of the fractionator (1);
an inlet pipe (11) disposed above the fractionator (1) injects salt water in the fractionator (1);
a top product outlet pipe (12) disposed above the fractionator (1) discharges water vapor out of the fractionator (1); and
at least, one tray (4) disposed inside the fractionator (1) equidistantly arranged in neat stack; the tray (4) is composed of a plurality of heat pipe (40) filled with working fluid mixed with nano-scale metallic particulates; the heat pipes (40) are arrayed in parallel to one another and equidistantly supported on a hollowed-out frame (41) at an inclined angle (θ).

2. A porous honeycomb water treatment device as claim 1 claimed wherein the tray (4) is electrically connected to a thermostat (3) for alternating cooling down and heat up process by the tray (4).

3. A porous honeycomb water treatment device as claim 1 claimed wherein the vertical aligned trays (4) substantially construct interleaved arrays of heat pipes (40) oriented transversally in an up and down relationship on neighbored trays.

4. A porous honeycomb water treatment device as claim 3 claimed wherein the heat pipes (40) on two neighbored trays (4) are interleaved with each other at a right angle (90°).

5. A porous honeycomb water treatment device comprising:
a hollow, vacuum, and high pressure vapor fractionator (1);
a bottom product exit (13) formed at a bottom of the fractionator (1);
at least, one inlet pipe (11) disposed above the fractionator (1) injects salt water in the fractionator (1);
a top product outlet pipe (12) disposed above the fractionator (1) discharges water vapor out of the fractionator (1); and
at least, one set of trays (4) fit through the fractionator (1) are equidistantly arranged, each of the trays (4) is composed of a plurality of heat pipes (40) arrayed in parallel to one another and equidistantly supported on a hollowed-out frame (41) at an inclined angle (θ), at least, a tray (4) clad with a condenser (43) at a higher end to wrap around higher ends of the heat pipes (40), and the tray (4) clad with a heating device (42) at a lower end to wrap around lower ends of the heat pipes (40).

6. A porous honeycomb water treatment device as claim 5 claimed wherein said heating device (42) and condenser (43) are electrically connected to a programmable logic controller (PLC) (30), and under control of the PLC.

7. A porous honeycomb water treatment device as claim 5 claimed wherein said heating device (42) includes evaporators (422) wrap up lower ends of the heat pipes (40), and the evaporators (422) fixed to a hollowed out frame (421), and the lower ends of pipes, evaporators, and hollowed out frame are clad with a housing (420).

8. A porous honeycomb water treatment device as claim 7 claimed wherein the evaporator (422) is a heat pipe made of quartz.

9. A porous honeycomb water treatment device as claim 5 claimed wherein the condenser (43) includes a housing (430) wraps up higher ends of the pipes (40), cooling pipes (431) in connection with the housing (430) for drawing in water as coolant, and exhaust pipes (432) in connection with the housing for expelling out water.

10. A porous honeycomb water treatment device as claim 1 claimed wherein an inclined angle is in the range of 5°˜45°.

11. A porous honeycomb water treatment device as claim 1 claimed wherein the salt water inlet pipe is connected to, at least, one sprinkler (2) disposed inside the fractionator (1) in opposite to an uppermost tray (4) and a distance is kept in between.

12. A porous honeycomb water treatment device as claim 5 claimed wherein the salt water inlet pipe is connected to, at least, one sprinkler (2) disposed inside the fractionator (1) in opposite to an uppermost tray (4) and a distance is kept in between.

13. A porous honeycomb water treatment device as claim 1 claimed wherein a relief valve (121) is disposed to the outlet pipe (12).

14. A porous honeycomb water treatment device as claim 5 claimed wherein a relief valve (121) is disposed to the outlet pipe (12).

15. A porous honeycomb water treatment device as claim 1 claimed wherein a weight valve (131) disposed to the bottom product exit (13) in response to an accumulated brine carry a weight, the weight valve (131) is open to drain out the brine.

16. A porous honeycomb water treatment device as claim 5 claimed wherein a weight valve (131) disposed to the bottom product exit (13) in response to an accumulated brine carry a weight, the weight valve (131) is open to drain out the brine.

17. A porous honeycomb water treatment device as claimed in claim 1 wherein a top of the vapor chamber (1) is cambered in shape.

18. A porous honeycomb water treatment device as claimed in claim 1 wherein a top of the vapor chamber (1) is pyramidal in shape.

19. A porous honeycomb water treatment device as claimed in claim 5 wherein a top of the vapor chamber (1) is cambered in shape.

20. A porous honeycomb water treatment device as claimed in claim 5 wherein a top of the vapor chamber (1) is pyramidal in shape.
